(19) United States
(12) Patent Application Publication
(10) Pub. No.: US 2009/0136696 A1
(43) Pub. Date: May 28, 2009

(54) Printing Ink System For Printing On Polyamide-Based Food Casings, Printed Food Casings And Process For Their Production

(76) Inventors: Ralf Faltermeier, Heidenrod (DE); Olaf Gauger, Nackenheim (DE); Hans-Werner Seelgen, Idstein (DE); Alexander Morast, Fuerstenau (DE); Hans-Peter Seng, Suessen (DE)

Correspondence Address: PROPAT, L.L.C., 425-C SOUTH SHARON AMITY ROAD, CHARLOTTE, NC, 28211-2841, US

(21) Appl. No.: 12/272,827

(22) Filed: Nov. 18, 2008

(30) Foreign Application Priority Data
Nov. 22, 2007 (DE) 10 2007 056 477.7

(51) Int. Cl. A22C 13/00; C08J 3/28; B32B 1/08; C08F 2/48; B32B 27/34

(52) U.S. Cl. 428/34.8; 522/153; 428/195.1; 428/35.2; 427/493

(57) ABSTRACT

A one-ply or multi-ply food casing based on (co)polyamide, or which has an outer ply based on (co)polyamide, is disclosed that is printed with a printing ink cured by a free radical mechanism. The printing ink is printed on a layer of a base ink which also cures by a free radical mechanism. The base ink contains, in one and the same molecule, at least one group which can form a bond with the (co)polyamide surface, in particular an isocyanate group, and at least one ethylenically unsaturated group which can undergo a free radical polyaddition reaction, in particular a (meth)acrylate group. The print adheres firmly on the casing and is abrasion- and scratch-resistant, even without additional varnish.

### CROSS-REFERENCE TO RELATED APPLICATIONS

This application claims priority to German Patent Application No. 10 2007 056 477.7 filed Nov. 22, 2007 which is hereby incorporated herein by reference in its entirety.

### FIELD OF THE INVENTION

The invention relates to a printing ink system for printing on polyamide-based films, one-ply or multi-ply films printed therewith and intended for use as food casings, in particular synthetic sausage casings, and process for their production.

### BACKGROUND OF THE INVENTION

Printed food casings are widely used in the food industry, for example as packagings for sausage, cheese or ready meals. A considerable part of the food casings used is based on one-ply or multi-ply substrate casings comprising thermoplastic polymers, the surface of which has multicolor imprints. For the packaging of many kinds of sausage varieties, thermally shrinkable food casings are required.

Printed sausage casings can be produced by various, customary printing processes. In practice, two processes have become established, flexographic printing and gravure printing. Sausage casings are generally printed on the outside since the hygiene regulations of many countries prohibit direct contact of the printing ink with the sausage meat. In the case of sausage casings comprising multi-ply plastic webs that are provided with a seam after tube formation it is possible to arrange the imprint in a protected manner between two plies. Gravure printing is frequently used for this purpose. Printing on sausage casings must be carried out in such a way that the printed image changes neither during storage and processing of the sausage casings nor during distribution of the finished sausages and no adverse side effects occur. Accordingly, the following requirements must be met by the imprinted layer:
neutral behavior toward the substrate casing,
neutral behavior toward the content (the sausage meat),
resistance to fat and water,
resistance to salt and brine,
resistance to spices and seasonings,
temperature resistance,
inert towards fumes,
abrasion resistance,
aging resistance,
light stability,
strength in the case of dimensional changes, i.e. yielding of the printed image when the sausage casing is subjected to stretching and shrinkage processes.

The flexographic printing inks used for this purpose are generally solvent-based inks having relatively low solids contents, which are made lower the higher the printing speed. They consist of colored pigments, binders, additives and solvent or solvent mixtures. For multicolor prints, the substrate casing to be printed passes through a plurality of inking stations in which in each case a printing ink is applied. In the case of certain sausage casings, for example in the case of colored synthetic sausage skin, light, in particular white, shades are printed in duplicate in order to achieve sufficient ink coverage.

Modern printing presses as are used today for printing on plastic films, in particular sausage skins based on plastic, are so-called central cylinder presses which are equipped with up to 8 inking units. In them, the inking stations are arranged around a large, generally water-cooled cylinder. The substrate casing is fed around the central cylinder and is imprinted with the inks of different shades in the inking stations under the same tension conditions.

The printing presses have the following mode of operation: the substrate casing running from a roll in an unwinding station is fed via deflection rolls and positioned on the rolls by means of so-called lateral edge control devices. Thereafter, the substrate passes through a corona station for print pretreatment, which corona station need not be in operation in the case of substrate casings comprising natural raw materials (cellulose, collagen, tissue, etc.). Before arriving there, the substrate casing is placed around the central cylinder with rolls and fed past the inking stations and imprinted. Dryer devices which dry the printing ink before the respective next imprint are present between the printing units. The printed substrate casing then passes through a drying tunnel in which the final drying is effected, predominantly with heated air and/or radiant heaters. After conditioning and possible dusting with a powder as a spacer, the completely imprinted substrate casing is wound up again.

The inking stations consist of an ink trough in which the printing ink is stored, one or more ink metering rolls and a plate cylinder on which a laser-engraved rubber or photopolymeric plastic plate is fastened. In the case of large print runs, the plate can be produced directly by the laser engraving of the plastic surface of the cylinder. Such printing cylinders are referred to as sleeves. A ink metering rolls may be rubber or plastic rolls or engraved rolls comprising metal with and without a ceramic surface and with or without a doctor blade device. In the case of high printing speeds, the ink trough with the doctor blade device can be encapsulated. The chambered doctor blade device is then used. The raised part-surfaces of the plate on the plate cylinder are wetted by the metering roll with printing ink, which is transferred from there to the surface of the substrate casing. Once the ink application is complete, the solvent used must be removed by drying in an air stream or by means of heating in the drying tunnel. The printed substrate casing is then wound up and is subjected to final processing operations after a curing time, which may be necessary.

The following are used as printing ink:
one-component flexographic printing inks based on solvents or solvent mixtures,
one-component flexographic printing inks which are radiation-curing,
two-component flexographic printing inks, so-called reactive inks, which consist of the components ink and curing agent

The one-component flexographic printing ink based on solvents can be printed without preparation apart from establishing the correct printing viscosity. These inks have a limited field of use since, owing to their poorer adhesion, they are not suitable for every polymeric substrate casing.

The one-component flexographic printing ink curing under the action of radiation has only recently been used for printing on polymeric substrate casings, approximately the quality of gravure printing being achieved. In the case of printing on polymeric substrate casings, the curing is effected by means of UV radiation which is generated using mercury quartz lamps. This printing process is also referred to as flexographic printing with UV-curing printing inks. There are in principle two types of UV-curing printing inks having different compositions, those with free radical-curing chemical reactions and others with cationic curing. For food casings, cationically curing inks are preferably used since they comply in their composition with the regulations under food law and moreover have better performance characteristics. The UV-curing printing inks are solvent-free and are therefore not subject to the laws and provisions for flammable liquids. The imprinted sausage casings are free of solvent residues. The ink can be printed without problems and at high speed and permits fine halftone printing up to 65 lines per cm, which is equivalent to gravure printing. The UV-curing printing inks are also suitable for four-color halftone printing. By printing the screen dots one on top of the other or side by side, different colors are perceptible to the human eye. Thus, a green color impression can be produced, for example, by means of yellow and blue screen dots printed side by side. During the curing of the printing ink with UV light, a photoinitiator present in the printing ink initiates polymerization which leads to curing of the printing ink. In the corresponding printing press, the quartz lamps generating UV light are arranged between the inking stations so that a drying tunnel is no longer required.

In the case of the two-component flexographic printing inks which are printed with added curing agent, the components are to be mixed together directly before the beginning of printing in a certain ratio and must be used in a specified time so that the induced chemical crosslinking of the printing ink takes place on the surface of the substrate casing. Owing to the limited processing time, the short potlife and the absence of the possibility of reuse, this ink system gives rise to high printing costs.

In the case of the two-component flexographic printing inks, there are a few known variants which arise through the use of different solvents, in particular solvent-based, alcohol-based and water-based printing inks. Owing to the long reaction time, which as a rule is from 2 to 3 days, the final processing is delayed. The admixing of curing agent on the other hand increases the adhesion of the ink on the surface of the sausage casing, so that casings which are also produced from natural raw materials, such as, for example, collagen, cellulose or tissue, can also be safely printed thereon with good adhesion.

WO 02/081576 discloses an aqueous UV-curing composition for imprinting and coating, which contains
water as a solvent,
a water-soluble component having at least one α,β-ethylenically unsaturated, radiation-polymerizable group,
optionally dyes or pigments and
optionally photoinitiators which form free radicals in the case of UV irradiation.

The water-soluble component is preferably a water-soluble oligomer having two or more acrylate groups. Furthermore, WO 02/081576 relates to a process in which a substrate is imprinted or coated with the composition and the composition is then cured by UV radiation to give a film. Inter alia, flexographic printing is mentioned as a printing process. Packaging materials for food, comprising various thermoplastic polymers, such as polyamide, are described as the substrate. The cured film has good adhesion on the substrate and high abrasion resistance. However, aqueous compositions require long drying times and are therefore not very suitable for the high printing speeds strived for.

U.S. Pat. No. 5,407,708 (whose European equivalent is EP 0 741 644 B1) discloses a process for flexographic printing of food packagings, in which a plurality of layers of a UV radiation-curing printing ink are applied to a heat-shrinkable, flexible web and are partly or completely cured by irradiation with ultraviolet light (UV) or with electron beams (EB). Here, freshly applied printing inks are partially cured between the inking stations of the flexographic printing press by means of UV light; finally, the total imprint is completely cured under the action of EB. The amount of photoinitiators in the radiation-cured printing ink may be less than 10% by weight. The application of a primer before the printing is not mentioned. Furthermore, no mention is made of packagings based on polyamide or copolyamide, which cannot readily be imprinted with UV-curable printing inks.

U.S. Pat. No. 7,063,882 (whose German equivalent is DE 601 22 503) describes an ink system in combination with an overprint varnish system for flexographic printing on thermally shrinkable polymeric packaging casings for food. The printing side of the packaging casings may consist of polyamides, such as nylon. The overprint varnish system curable with electron beams or ultraviolet light (UV) contains
i) monomers having a low viscosity (reactive diluents),
ii) oligomers/prepolymers (e.g. acrylates) and optionally
(iii) other additives, such as unreactive plasticizer diluents.

Preferably, the curing of the overprint varnish system is based on a free radical mechanism. The UV-curable overprint varnish systems contain one or more photo-initiators. The ink system may be radiation-curable and may contain one or more coloring agents (e.g. pigments) together with monomers and oligomers/prepolymers (analogously to the overprint varnish system) Preferably, the radiation-curable ink system is virtually free of photoinitiators.

Before the application of the ink system, the packaging casing can be treated with a primer. However, the application and curing of an overprint varnish means additional operations, which makes the process as a whole disadvantageous.

### SUMMARY OF ADVANTAGEOUS EMBODIMENTS OF THE INVENTION

In the food packaging industry, there is a need for a solvent-free and substantially UV-curing printing system which requires no final curing by means of electron beams. It should in particular be suitable for flexographic printing and permit a high printing speed (up to 150 m/min or more). In particular, it should be possible therewith to print on surfaces which substantially comprise polyamides and/or copolyamides. The printed image should be firmly anchored on the substrate and should not change even under the action of oils or fats, hot water or other substances occurring in the production of packed foods.

It is the object of the invention to provide a printed film based on (co)polyamide, in particular a printed tubular food casing based on (co)polyamide, which film has the following properties:
strong adhesion on the surface of the casing even without prior corona treatment of the surface,
high abrasion and scratch resistance;
resistance to mechanical and thermal effects to which food, such as, for example, sausage, are exposed during filling, packing, aftertreatment, storage and transport;
low residual odor;
no impairment of the taste of foods which come into contact with the imprint;
less than 10 mg/dm² of extractable residues;
no overprint varnish necessary;
no use of water-containing printing inks;
high-gloss or dull or very dull prints can be achieved.

### DETAILED DESCRIPTION OF ADVANTAGEOUS EMBODIMENTS OF THE INVENTION

This object is achieved by a printing ink system which is comprised of a base ink and at least one printing ink curing by a free radical mechanism. The base ink comprises, as substantial component, a compound which contains two different types of reactive groups. One of these may form a bond with the (co)polyamide surface, in particular by a (poly)condensation reaction. The groups of the other type are ethylenically unsaturated groups which can undergo a free radical polyaddition reaction. In particular, these are (meth)acrylate groups.

The invention accordingly relates to a printing ink system for printing on films having a print-side surface based on (co)polyamide with a base ink curing by a free radical mechanism and at least one UV-curing printing ink curing by a free radical mechanism, the base ink comprising a reactive compound which, in one and the same molecule,
a) contains at least one group which can form a bond with the (co)polyamide surface; and
b at least one ethylenically unsaturated group which can undergo a free radical polyaddition reaction.

The reactive compound is a monomer, oligomer and/or prepolymer. Low-viscosity monomers having olefinic double bonds capable of free radical polymerization are particularly suitable, preferably tripropylene glycol di(meth)acrylate, dipropylene glycol di(meth)acrylate, hexanediol di(meth)acrylate or trimethylolpropane tri(meth)acrylate. The group which can form a bond with the (co)polyamide surface is an isocyanate group. A (meth)acrylate group is used as the ethylenically unsaturated group.

The base ink curing by a free radical mechanism may comprise monomers, oligomers and/or prepolymers curing under the action of UV radiation or electron beams by a free radical mechanism and having polymerizable ethylenically unsaturated groups.

The following compounds are preferably used as monomers: trimethylolpropane tri(meth)acrylate, hexanediol di(meth)acrylate, 1,3-butylene glycol di(meth)acrylate, diethylene glycol di(meth)acrylate, 1,6-hexanediol diacrylate, neopentyl glycol di(meth)acrylate, polyethylene glycol-200 di(meth)acrylate, tetraethylene glycol diacrylate, triethylene glycol diacrylate, pentaerythrityl tetra(meth)acrylate, tripropylene glycol diacrylate, ethoxylated bisphenol A di(meth)acrylate, propylene glycol mono- or dimethacrylate, trimethylolpropane tri(meth)acrylate, ditrimethylolpropane tetraacrylate, triacrylate of tris(hydroxyethyl) isocyanurate, dipentaerythrityl hydroxypentaacrylate, pentaerythrityl tri(meth)acrylate, ethoxylated trimethylolpropane tri(meth)acrylate, triethylene glycol di(meth)acrylate, ethylene glycol di(meth)acrylate, tetraethylene glycol dimethacrylate, polyethylene glycol-600 di(meth)-acrylate, 1,4-butanediol di(meth)acrylate, glyceryl dimethacrylate, pentaerythrityl di(meth)acrylate, aminoplast (meth)acrylates; acrylated oils, such as linseed oil, soybean oil and castor oil, (meth)acrylamides, maleimides, vinyl acetate, vinyl caprolactam, polythiols and vinyl ethers. The designation (meth)acrylate is to be understood as meaning acrylate and/or methacrylate.

In particular, the base ink comprises a compound having at least one isocyanate and at least one (meth)acrylate group. The isocyanate groups react with water with formation of urethane groups. A reaction with terminal carboxyl groups of the (co)polyamide may also occur and thus produces a strong link, in particular a covalent bond, to the (co)polyamide. However, the exact reaction mechanism has not yet been clarified. The curing of the base ink by reaction of the two different types of reactive groups is also referred to below as “dual-cure”.

The oligomers or prepolymers used in the base ink are in particular resins having an acrylate function, such as epoxy acrylates, polyurethane acrylates and polyester acrylates, (meth)acrylated epoxy resins, (meth)acrylated polyesters, (meth)acrylated urethanes/polyurethanes, (meth)acrylated polyethers, (meth)acrylated polybutadienes, aromatic acid (meth)acrylates, (meth)acrylated acryloyloligomers or polymers of diisocyanatohexane with hydroxyalkyl esters of propionic acid.

The base ink curing by a free radical mechanism has a viscosity of from 0.2 to 0.7 Pa·s, preferably of about 0.3 Pa·s.

The UV-curing printing ink curing by a free radical mechanism comprises monomers, oligomers and/or prepolymers and colored pigments and at least one photoinitiator. The UV-curing printing ink curing by a free radical mechanism has a viscosity of from 1.0 to 3.0 Pa·s, preferably from 1.5 to 2.5 Pa·s.

The invention furthermore relates to a one-ply or multi-ply film which is printed with printing inks curable by a free radical mechanism and is based on (co)polyamide or has an outer ply based on (co)polyamide, wherein the printing ink is printed on a layer of a base ink which cures by free radical mechanism and which, in one and the same molecule,
a) contains at least one group which can form a bond with the (co)polyamide surface, in particular by a (poly)condensation reaction, and
b) at least one ethylenically unsaturated group which can undergo a free radical polyaddition reaction.

In the context of the present invention, the designation (co)polyamide is to be understood as meaning polyamide, copolyamide, block copolymers comprising blocks of polyamides and/or copolyamides and any desired mixtures thereof. The reactive compound in the base ink preferably forms covalent bonds with the (co)polyamide surface.

The base ink is applied very thinly to the (co)polyamide-containing surface. The coat weight is preferably not more than 2.0 g/m², particularly preferably 1.0 g/m² or less. For this purpose, the base ink must have a relatively low viscosity. It is preferably from 0.2 to 0.7 Pa·s, particularly preferably about 0.3 Pa·s. The desired viscosity can be achieved by admixing reactive diluents, for example low-viscosity monomers having olefinic double bonds capable of free radical polymerization, such as tripropylene glycol diacrylate (TPGDA), dipropylene glycol diacrylate (DPGDA), hexanediol diacrylate (HDDA) or trimethylolpropane triacrylate (TMPTA). The viscosity can in principle also be reduced by admixing a (nonreactive) organic solvent.

However, an additional drying step is then necessary and the application of the base ink can no longer be carried out in an in-line process. Solvent-free base inks are therefore preferred. In any case, the base ink, as well as the printing ink, is anhydrous.

The base ink coat is virtually colorless. In order to monitor the print quality, the base ink therefore expediently also contains a marking substance not visible to the naked eye, for example a luminescent pigment.

In general, the base ink is applied uniformly. However, it is also possible in principle to apply the base ink imagewise, i.e. only in the parts which are subsequently to be printed with the ink curable by a free radical mechanism.

The base ink moreover contains at least one photoinitiator which can initiate free radical polymerization of ethylenically unsaturated monomers. Such initiators are generally known. They include, for example, methyl ethyl ketone, acetophenone, dialkoxyacetophenones, benzaldehyde, benzophenone, 4-aminobenzophenone, benzoin alkyl ethers, dibenzosuberone, fluoren-9-one, indan-1-one and thioxanthen-9-one, α-aminoalkylphenones, also those having a polymeric structure, alkylbenzoylarylphosphine oxides, hydroxyalkyl aryl ketones, polymeric benzophenone derivatives and polymeric aminobenzoate derivatives. The photoinitiators should have a low vapor pressure, form no undesired byproduct on irradiation and not discolor the cured base ink coat. The action of the photoinitiators can be enhanced by coinitiators. The proportion of all initiators (including the coinitiators) is expediently up to 10% by weight, based on the weight of the monomers.

The irradiation is generally effected with UV radiation, but electron beams can in principle also be used. In order to achieve a sufficient crosslinking, an irradiation time of less than 2 sec, preferably less than 1 sec, is generally sufficient.

As far as possible immediately after the irradiation, the ink curable by a free radical mechanism is used for printing. As a rule, inks of different colors which are curable by a free radical mechanism are printed in a plurality of printing stations (generally from 3 to 6). The inks curable by a free radical mechanism are expediently solvent-free. A print produced using printing ink curable by a free radical mechanism has substantially less odor than one produced with a cationically curable printing ink.

In no event may the base ink be mixed with the printing ink and irradiated thereafter. This would not enable the objects of the invention to be achieved. The print would then no longer be sufficiently anchored on the surface of the casing. The printing ink should be applied as quickly as possible, i.e. as far as possible within seconds or minutes, after the irradiation of the base ink coat. Particularly good adhesion of the print on the base ink coat is then achieved. It is presumed that the base ink coat then still contains free radicals which can also react with polymerizable, olefinically unsaturated compounds in the printing ink. If on the other hand the printing ink is applied only after some time, i.e. for example after a few days, the adhesion of the print on the base ink coat is then insufficient.

As in the case of the base ink, the printing ink curable by a free radical mechanism contains at least one photoinitiator. The photoinitiators in the printing ink may be identical to or different from those in the base ink. The photoinitiator in the printing ink must be capable of forming free radicals which initiate the polyaddition of monomers having ethylenically unsaturated bonds.

The UV-curing printing ink curable by a free radical mechanism contains monomers, oligomers and/or prepolymers, which in each case have polymerizable olefinic double bonds, photoinitiators, dyes or colored pigments, optionally also binders. It is preferably solvent-free. It expediently has a viscosity of from 1.0 to 3.0 Pa·s, preferably from 1.5 to 2.5 Pa·s.

In a particular embodiment, the printed film is a tubular film, especially a seamless tubular film. The tubular film serves in particular as a food casing, especially as a synthetic sausage casing.

The invention accordingly also relates to a process for the production of the printed film, comprising the steps:
(a) provision of a one-ply or multi-ply film whose surface to be printed substantially comprises (co) polyamides;
(b) optionally pretreatment of the surface of the film by corona discharge;
(c) imprinting on the surface of the film with dual-cure base ink curing by a free radical mechanism;
(d) curing of the base ink by means of UV light and/or electron beams, a cured base ink coat being formed;
(e) imprinting with a UV-curing printing ink curing by a free radical mechanism;
(f) curing of the printing ink by irradiation with UV light, a cured print being formed, and
(g) optionally one or more repetitions of steps (e) and (f).

The film is preferably tubular, in particular seamless and tubular. It is generally printed on in a flexographic printing process, it being possible for the printing speed to be greater than 100 m/min, preferably greater than 120 m/min and particularly preferably greater than 140 m/min.

It is known that the various polyamides or copolyamides absorb up to 10% by weight, based on their weight, of water. Before the printing by the process according to the invention, the (co)polyamide surface need not be predried. The water generally present in the film or film ply based on (co)polyamides has even proven to be advantageous for the purposes of the present invention.

The base ink coat and the ink coats are resistant to the action of ice, water and steam at temperatures from −20 to +115° C. The total migration of the imprinted casing is determined by extraction with water according to European standard EN 1186-5 or with olive oil according to EN 1186-4, according to the European Migration directives 97/48/EC and 85/572/EEC (test conditions: 4 h/100° C., then for 10 days at 40° C.). The extraction is effected only on the inside. It was found that, under these conditions, less than 10 mg per dm² of the imprinted film can be extracted and the prescribed limits are therefore not exceeded.

The imprinted film according to the invention may also be tubular. It is then suitable as a food casing, in particular as a synthetic sausage casing. Sausage casings generally exhibit a shrinkage of less than 20% in the longitudinal and transverse directions on heating in water at about 80° C. In the case of the film according to the invention, the print does not become detached even in the case of such thermal shrinkage, which is a problem in the case of known casings.

That which is claimed:

1. A printing ink system for printing on films having a print-side surface based on (co)polyamide comprising a base ink curing by a free radical mechanism and at least one UV-curing printing ink curing by a free radical mechanism, wherein the base ink comprises a reactive compound which, in one and the same molecule, comprises
a) at least one group which can form a bond with the (co)polyamide surface; and
b) at least one ethylenically unsaturated group which can undergo a free radical polyaddition reaction.

2. The printing ink system as claimed in claim 1, wherein the reactive compound is a monomer, oligomer and/or prepolymer.

3. The printing ink system as claimed in claim 1, wherein the group which can form a bond with the (co)polyamide surface is an isocyanate group.

4. The printing ink system as claimed in claim 1, wherein the ethylenically unsaturated group is a (meth)acrylate group.

5. The printing ink system as claimed in claim 1, wherein the reactive compound is a low-viscosity monomer having olefinic double bonds capable of free radical polymerization.

6. The printing ink system as claimed in claim 1, wherein the UV-curing printing ink curing by a free radical mechanism comprises monomers, oligomers and/or prepolymers and colored pigments and at least one photoinitiator.

7. The printing ink system as claimed in claim 1, wherein the base ink curing by a free radical mechanism has a viscosity of from 0.2 to 0.7 Pa·s.

8. The printing ink system as claimed in claim 1, wherein the UV-curing printing ink curing by a free radical mechanism has a viscosity of from 1.0 to 3.0 Pa·s.

9. A one-ply or multi-ply film comprising print formed by a printing ink cured by a free radical mechanism, said film based on (co)polyamide or having an outer ply based on (co)polyamide, wherein the printing ink is printed on a layer of a base ink cured by a free radical mechanism, the base ink comprising a reactive compound which, in one and the same molecule, contains
a) at least one group forming a bond with the (co)polyamide surface and
b) at least one ethylenically unsaturated group which has undergone a free radical polyaddition reaction.

10. The printed film as claimed in claim 9, wherein the reactive compound is a monomer, oligomer and/or prepolymer.

11. The printed film as claimed in claim 9, wherein the group forming a bond with the (co)polyamide surface is an isocyanate group.

12. The printed film as claimed in claim 9, wherein the ethylenically unsaturated group is a (meth)acrylate group.

13. The printed film as claimed in claim 9, wherein the UV-curing printing ink curing by a free radical mechanism comprises monomers, oligomers and/or prepolymers and colored pigments and at least one photoinitiator.

14. The printed film as claimed in claim 9, wherein said film is tubular.

15. The printed film as claimed in claim 14, wherein said film is a food casing.

16. The printed film as claimed in claim 14, wherein the base ink and the printing ink are resistant to the action of ice, water and steam at temperatures of from −20 to 115° C.

17. The printed film as claimed in claim 14, wherein the base ink and the printing ink are resistant to thermal shrinkage of the film in the longitudinal and/or transverse directions of in each case up to 20%.

18. The printed film as claimed in claim 15, wherein the total migration, measured according to EN 1186-5 with water as simulation liquid and according to EN 1186-4 with olive oil as simulation liquid on the inside of the printed casing after a duration of action of 4 hours at 100° C. and 10 days at 40° C., is less than 10 mg/dm².

19. A process for the production of a printed film, comprising the steps:
(a) providing a one-ply or multi-ply film having a surface based on (co)polyamide,
(b) optionally pretreating the surface by corona discharge;
(c) printing the film with a base ink which cures by a free radical mechanism, said base ink comprising a compound having at least one group which can form a bond with the (co)-polyamide surface and at least one ethylenically unsaturated group which can undergo a free radical polyaddition reaction,
and at least one photoinitiator;
(d) curing the base ink using UV light and/or electron beams, thereby forming a cured base ink coat;
(e) printing the cured based ink coat with a printing ink that cures by a free radical mechanism;
(f) curing the printing ink using UV radiation, thereby forming a cured print ink coat; and
(g) optionally repeating one or more of the steps (e) and (f).

20. The process as claimed in claim 19, wherein said base ink comprises at least one reactive diluent.

21. The process as claimed in claim 20, wherein said reactive diluent comprises low-viscosity monomers having olefinic double bonds capable of free radical polymerization.

22. The process as claimed in claim 19, wherein the base ink has a viscosity of from 0.2 to 0.7 Pa·s.

23. The process as claimed in claim 19, wherein the base ink is applied to the film at a coat weight of not more than 2 g/m².

24. The process as claimed in claim 19, wherein the film is printed by flexographic printing.

25. The process as claimed in claim 19, wherein the printing ink curing by a free radical mechanism has a viscosity of from 1.0 to 3.0 Pa·s.

26. The process as claimed in claim 19, wherein said printing is at a printing speed of greater than 100 m/min.

27. The process as claimed in claim 19, wherein said film is tubular film.

28. The printing ink system as claimed in claim 5, wherein the reactive compound comprises tripropylene glycol di(meth)acrylate, dipropylene glycol di(meth)acrylate, hexanediol di(meth)acrylate or trimethylolpropane tri-(meth)acrylate.

29. The printing ink system as claimed in claim 7, wherein the base ink curing by a free radical mechanism has a viscosity of about 0.3 Pa·s.

30. The printing ink system as claimed in claim 8, wherein the UV-curing printing ink curing by a free radical mechanism has a viscosity of from 1.5 to 2.5 Pa·s.

31. The printed film as claimed in claim 14, wherein said film is seamless.

32. The printed film as claimed in claim 15, wherein said film is a synthetic sausage casing.

33. The process as claimed in claim 21, wherein said reactive diluent comprises low-viscosity monomers having tripropylene glycol diacrylate, dipropylene glycol diacrylate, hexanediol diacrylate or trimethylolpropane triacrylate moities.

34. The process as claimed in claim 22, wherein the base ink has a viscosity of about 0.3 Pa·s.

35. The process as claimed in claim 23, wherein the base ink is applied to the film with a coat weight of not more than 1 g/m².

36. The process as claimed in claim 25, wherein the printing ink curing by free radical mechanism has a viscosity of from 1.5 to 2.5 Pa·s.

37. The process as claimed in claim 26, wherein the printing speed is greater than 120 m/min.

38. The process as claimed in claim 26, wherein the printing speed is greater than greater than 140 m/min.

39. The process as claimed in claim 27, wherein said tubular film is seamless.
